(19) United States
(12) Patent Application Publication
(10) Pub. No.: US 2020/0014543 A1
(43) Pub. Date: Jan. 9, 2020

(54) IDENTITY AUTHENTICATION

(71) Applicants: COLIN PATERSON, Coventry (GB); Jean-Paul DELONG, London (GB)

(72) Inventors: COLIN PATERSON, Coventry (GB); Jean-Paul DELONG, London (GB)

(21) Appl. No.: 16/472,197

(22) PCT Filed: Dec. 21, 2017
(86) PCT No.: PCT/GB2017/053855

§ 371 Date: Jun. 21, 2019

(30) Foreign Application Priority Data
Dec. 21, 2016 (GB) 1621807.5

(51) Int. Cl. H04L 9/32; H04L 29/06; G06F 21/31

(52) U.S. Cl. CPC H04L 9/3236; H04L 63/083; H04L 63/0869; H04L 2463/102; H04L 9/321; H04L 9/3226; G06F 21/31

(57) ABSTRACT

The present invention relates to a method of authenticating the identity of one or more users (101, 102) who are communicating with each other. The users (101, 102) share one or more secrets with each other, and use those secrets to verify their identities at a remote authentication system (103). A server (104) of the system (103) receives a secret from a first user (102) and hashes it with a salt (206), sending a reference code (207) back to the first user (102) in response. The server (104) then receives the secret from a second user (101), along with the reference code (207) and hashes the secret with the same salt (206) used to hash the first secret. The outputs (208, 209) of the hashes are then compared to determine whether the secrets matched, authenticating the identities of each user.

### FIELD OF THE INVENTION

This invention relates to a system for authentication of a user's identity. More specifically it relates to a system in which an identity is verified by communication of a previously shared secret to a third party for verification.

### BACKGROUND OF THE INVENTION

As technology advances, businesses are capable of communicating with their customers in an increasing variety of ways. Unfortunately, with each new means of communication, more customers are susceptible to fraud. For example, with the growth of the internet, emails have become a cheap and simple way for fraudulent parties to attempt to convince unsuspecting members of the public to divulge sensitive information which may be used illicitly. One such example is a phishing attack, in which a fraudulent party sends an email to an individual, under the guise of a legitimate business, with directions to enter personal information at a fraudulent website or download malicious software on to their computer.

In addition to the above, advancements in telecommunications allow users to provide their identities when communicating with other users. In this manner, when a user receives an SMS, a smart phone can present to the user an identity of the sender of the SMS, even if the user has not previously stored the identity of the sender in their device. Similar methods of providing the identity of a sender exist for emails, telephone calls, traditional postal services, etc.

For example, a customer of a bank may receive an SMS on their smart phone from their bank regarding a recent transaction. The customer's device receives the message content and header data which enables the smart phone to display information regarding the identity of the sender. As such, the user is better informed as to the identity of an SMS sender.

Unfortunately, such systems which allow legitimate institutes to present their identity, in good faith, to their customers are open to abuse or malicious gain by parties wishing to hide their true identity. For example, a customer of a bank may receive an SMS which is identified as originating from their bank, but may, in reality, be from a fraudulent entity. Such an SMS may lead the customer to divulge sensitive information which should otherwise remain private between the customer and their bank, e.g., via a URL in the body of the message. Hence, there is a need to authenticate the identity of the sender of such messages.

In order to mitigate the risk of phishing attacks against customers, many financial institutes inform their customers that they will never ask for sensitive information when communicating across particular media. Therefore, should a customer receive an SMS which is identified as being from their bank and requesting sensitive information, the customer can assume that such a message is fraudulent. However, this method of protecting users requires an institute to inform each of their customers about the information which may be requested over different media. Further, the institutes are then limited by such requirements, in that they cannot, in good faith, request that information themselves without appearing fraudulent.

In an alternative solution to these authentication challenges, some institutes request that, before information is divulged by the customer, the customer contacts the institute themselves. In this manner, the customer is assured that they are speaking to the correct entity, since in such a situation the call to the institute will have been initiated by the customer. However, this method has its own drawbacks. For example, in some cases the phone number to be called may be provided by the institute which initiated the call.

This may lead to the user calling back a fraudulent entity and assuming that they are genuine. Further, it is not desirable for a call centre agent of an entity to end a telephone call with a customer, once the customer has accepted a call, as it can be difficult to reinitiate the communication immediately and for the customer to contact the same call centre agent.

Embodiments of the present invention aim to overcome these problems by providing an improved method of authenticating a user.

### SUMMARY OF THE INVENTION

In order to solve the problems associated with the prior art, a first aspect of the present invention provides a method of authentication, comprising: hashing, at a hashing module of a server, a first item of information provided by a first user with a salt to produce a first hashed output; storing, by the server, the salt and the first hashed output in a data object; generating, by a reference code module at the server, a reference code and storing it in the data object; providing, by the server, the reference code to a second user; receiving, by the server from the second user, a second item of information and the reference code; retrieving, by the hashing module, and with the reference to the reference code the stored salt from the data object; hashing, by the hashing module, the second item of information received from the second user with the retrieved salt to produce a second hashed output; comparing, at a hash comparison module of the server, the first hashed output with the second hashed output; and determining, by the hash comparison module, whether the first and second hashed outputs are the same, thereby determining whether the first and second items of information are the same.

The method may further comprise, before the first hashing step: sharing a plurality of items of information between the first user and the second user, wherein the first item of information is one of the plurality of shared items of information.

The first item of information may be a part of one of the plurality of the shared items of information.

The method may further comprise, before the first hashing step: selecting, by one or both of the first and second users, the first item of the plurality of items to be provided by the first and second users.

The reference code may be a shortened form of the first hashed output.

The first item may be sent to the hashing module via an application or a website.

The server may be remote from the first and second users.

One or more of the hashing module, the hashing comparison module and the reference code module may be located at a customer device.

The plurality of shared items of information may be two or more of: a date of birth, a mother's maiden name, a whole or part of an address, a school, a bank account number, a credit/debit card number, a personal identification number and a password.

The salt may be randomly generated by a salt generation module.

In a second aspect of the invention a method of authentication, comprises: sharing, between a first user and a second user, one or more secrets; receiving, at a hashing module and from the first user, a first secret of the shared secrets; hashing, at the hashing module, the first secret with a randomly generated salt to form a first hashed output; creating, by a reference module, a reference code relating to the salt and the first hashed output; storing, in a data object at a data object store, the reference code, the salt and the first hashed output; sending, from the data object store to the first user, the reference code; sending, by the first user to the second user, the reference code; receiving, at the hashing module and from the second user, the first shared secret and the reference code; retrieving, from the data object and based on the reference code, the salt; sending, to the hashing module by the data object store, the salt; hashing, by the hashing module, the first shared secret received from the second user with the salt to form a second hashed output; receiving, at a hash comparison module, the first hashed output from the data object store and the second hashed output from the hashing module; comparing, by the hash comparison module, the first hashed output with the second hashed output; determining, by the hash comparison module, whether the first and second hashed outputs are identical; and sending, by the hash comparison module, to one or both of the first and second users, a statement relating to the comparison.

In a third aspect of the invention a system of authentication comprises: a first user device; a second user device, in communication with the first user device; and a server, in communication with the first and second user devices via a network, comprising a hashing module, a reference code module and a hash comparison module, wherein the first user device, the second user device and the server are configured to perform the method steps of: hashing, at the hashing module, a first item of information provided by the first user device with a salt to produce a first hashed output; storing, by the server, the salt and the first hashed output in a data object; generating, by the reference code module, a reference code and storing it in the data object; providing, by the server and via the first user device, the reference code to the second user device; sending, by the second user device to the server, a second item of information and the reference code; retrieving, by the hashing module, and with reference to the reference code the stored salt from the data object; hashing, by the hashing module, the second item of information received from the second user with the retrieved salt to produce a second hashed output; comparing, at the hash comparison module, the first hashed output with the second hashed output; and determining, by the hash comparison module, whether the first and second hashed outputs are the same, thereby determining whether the first and second items of information are the same.

In a fourth aspect of the invention an authentication server stores instructions that, when executed, cause the server to perform the steps of: hashing a first item of information provided by a first user with a salt to produce a first hashed output; storing the salt and the first hashed output in a data object; generating a reference code and storing it in the data object; providing the reference code to a second user; receiving, from the second user, a second item of information and the reference code; retrieving, with reference to the reference code, the stored salt from the data object; hashing the second item of information with the retrieved salt to produce a second hashed output; comparing the first hashed output with the second hashed output; and determining whether the first and second hashed outputs are the same, thereby determining whether the first and second items of information are the same.

As will be appreciated, the present invention provides several advantages over the prior art. For example, since a customer is able to authenticate the identity of a sender/caller of a communication, once authenticated the customer can safely divulge sensitive information using their preferred media. Further, as the verification process can be performed in parallel to an ongoing telephone call, a customer is not required to end and reinitiate a telephone call, but may remain on the call while they authenticate the identity of the caller. Finally, not only can this invention be used to authenticate the identity of a telephone caller but it can also be used to authenticate the identity of senders of other communications, such as emails, letters, parcels, other packages etc.

### BRIEF DESCRIPTION OF THE DRAWINGS

Other advantages and benefits of embodiments of the present invention will become apparent from a consideration of the following description and accompanying drawings, in which:

FIG. 1 shows a block diagram of a system according to an embodiment of the present invention;

FIG. 2 shows a block diagram of a server of the system of FIG. 1;

FIG. 3 shows a flow diagram of a first part of method of implementing the invention in the system of FIG. 1;

FIG. 4 shows a flow diagram of a second part of the method; and

FIG. 5 shows a schematic of data flows for implementing the invention in accordance with the methods of FIGS. 4 and 5.

### DETAILED DESCRIPTION OF EXEMPLARY EMBODIMENTS

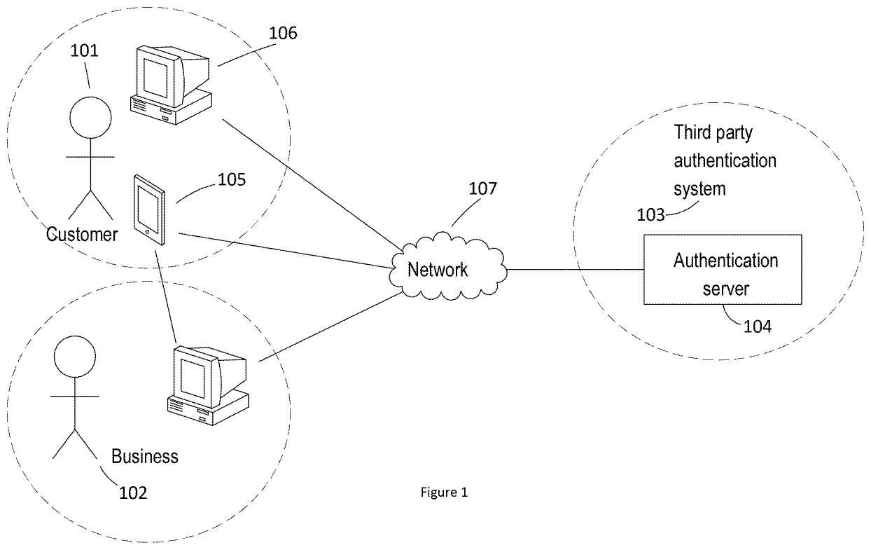

An authentication system and method in accordance with an exemplary embodiment of the present invention is shown in FIGS. 1 to 5.

Referring to FIG. 1, an embodiment of the present invention comprises a first user (e.g. a customer) 101; a second user (e.g. a business) 102; and a third party authentication system 103. The customer 101 communicates with the business 102 via a telephone 105, or computer 106, or any other form of communication device. The customer 101 and the business 102 communicate with the third party 103 at an authentication server 104, via any networked device, using a network 107, e.g., the internet.

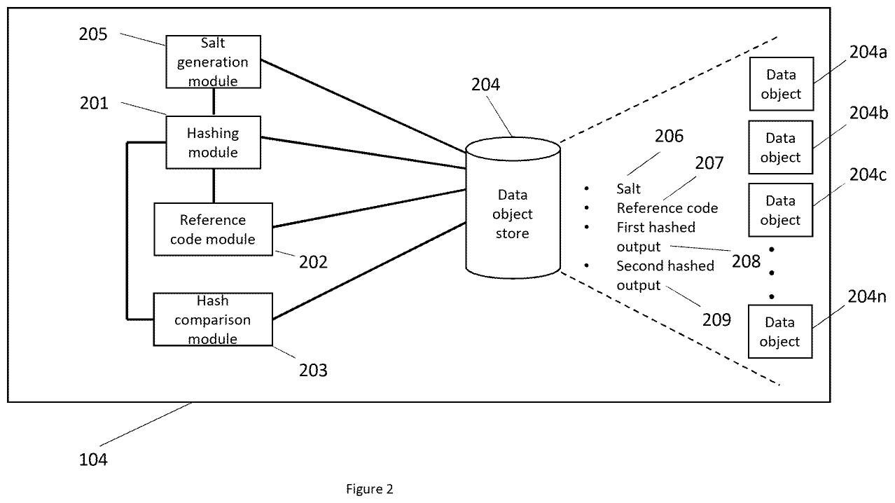

Referring to FIG. 2, the authentication server 104 of FIG. 1 comprises the following functional modules: a hashing module 201; a reference module 202; a hash comparison module 203; a data object store 204; and a salt generation module 205. The salt generation module 205 is used to generate a salt 206. The salt 206 is a string of random data which is used in conjunction with a data input to a hash function, making a hashed output 208 more difficult to decrypt using dictionary attacks and rainbow table attacks. The hashing module 201 is used to hash received data with the salt 206 and generate the hashed output 208 of that data using a hash function (for example, MD5 or SHA-1). The reference module 202 receives the hashed output 208 and reduces it to a shortened format, to be used as a reference code 207. The hash comparison module 203 receives two hashed outputs and compares them, outputting a true/false statement as to whether they match or not. The data object store 204 is used to store data objects 204a-n. Each data object 204a-n can include a salt 206, a reference code 207 and hashed outputs 208, 209 as is explained below.

In order for embodiments of the present invention to be implemented, a first user (e.g. a business) 102 and a second user (e.g. a customer) 101 are required to initially share certain private information in order to establish a trusted relationship. Such an exchange of information will generally take place during an initial encounter between the two entities. As an example, a customer, when opening a bank account, may provide the bank with their date of birth, their home address, their mother's maiden name, a password and/or other security information. Similarly, the bank may provide the customer with a bank account number, a sort code and a debit/credit card number. This information will generally remain known only between the bank and the customer, or is only shared further with entities that the users trust not to further share this information, and is referred to herein as a “shared secret”. As such, the possession of this information can be an indicator that an entity is trustworthy. During a subsequent communication between the business 102 and the customer 101, the identities of the business 102 and customer 101 are mutually verified using these shared secrets.

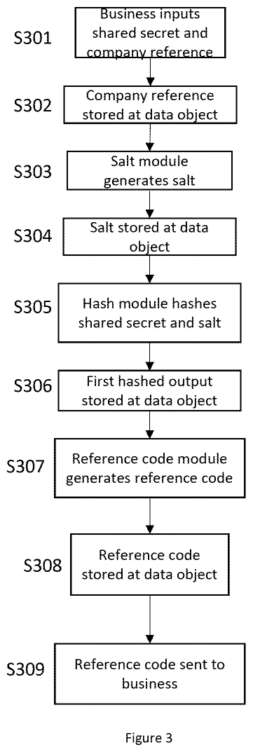

FIG. 3 shows a flow chart of a first part of the method embodying the invention. When a call centre agent of the business 102 calls the user 101, the call centre agent notifies the user 101 that they can mutually authenticate by using the method of this invention and the call centre agent asks the user 101 to select one of their shared secrets to be used during the subsequent authentication process. Once the business 102 and the customer 101 agree which shared secret is to be used to establish trust the business 102 encrypts the agreed shared secret and sends it to the third party authentication server 104 in conjunction with a company reference at step S301. The information provided may be a full secret, e.g., a date of birth, or part of a secret, e.g., the last four digits of a debit card number. Note that since the shared secret is sent to the authentication server 104 without any data identifying the customer 101 the shared secret has no value to an unrelated party in the absence of the context of the identity of the customer 101. In other words, if the shared secret were to be intercepted by an unscrupulous third party then it cannot be used since it is not associated with customer 101.

The company reference is used for administrative purposes. For example the third party 103 may use it to identify the business 102 which is requesting use of the authentication system and to establish that it is subscribed to the third party's 103 authentication service and is entitled to use that service. In this manner, the third party 103 may pre-authorise businesses 102 to use the system, ensuring a further layer of security and confidence for the customer 101. The company reference may also be used to aid invoicing of businesses 102 for use of the system. For these purposes, the company reference is stored at the data object store at step S302.

Following receipt of the shared secret at the authentication server 104, at step S303 the salt generation module 205 generates a random salt 206. The generated salt 206 is stored in a data object 204a at step S304. At step S305, the hashing module 201 then applies a hash to the shared secret and the generated salt 206 to generate a first hashed output 208. At this point, the server 104 discards any information relating to the shared secret, since this is not used subsequently in the process and such that there is no longer any cleartext form of the information. The first hashed output 208 is stored in the data object 204a at step S306 and also sent to the reference module 202. The reference module 202 operates a shortening process (for example, a minification process) S307 on the first hashed output 208 which produces a simple identifier (or reference code) 207 of the first hashed output 208 which is in a more user friendly format than the first hashed output itself. For example, a 128 bit hashed output may be shortened to a unique reference code 207 of a form “PTLM345”. The reference code 207 is stored in the data object 204a at step S308. Finally, the reference code 207 is sent back to the business 102 at step S309. It is displayed on the call centre agent's screen and passed on to the customer 101, for example verbally over the phone or by using an SMS.

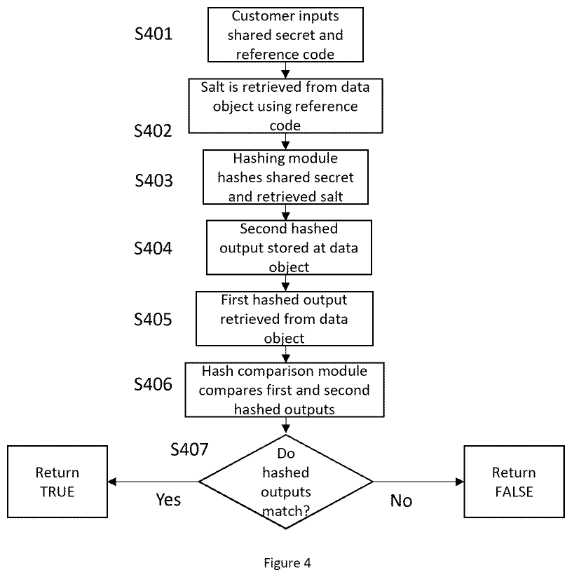

Referring now to FIG. 4, at step S401 once the customer 101 has received the reference code 207 from the business 102, the customer 101 may then input the shared secret and the reference code 207 into a third party API used to interact with the third party server 104. The customer 101 may be running the API as part of an app on their smart phone or via a browser on their on their smartphone (which could be telephone 105) or a computer terminal 106. The shared secret entered by the user 101 is encrypted before it is sent to the authentication server 104. Since the reference code 207 is stored in the same data object 204a as the unique salt 206 and the first hashed output 208, at step S402 the reference code 207 is used to retrieve the unique salt 206 which was used to generate the first hashed output 208. As above, the shared secret provided by the customer 101 is hashed with the retrieved salt 206 using the hashing module 201 at step S403. If the shared secret and the reference code 207 provided by the customer 101 match those previously provided by the business 102, then the inputs into the hashing module 201 at step S403 will be the same as those in step S305. In such a situation, the hashed output of the customer's inputs (the second hashed output) 209 will match the hashed output of the business' inputs (the first hashed output) 208. If any of the inputs to the hashing module are different, then the second hashed output 209 will be different to the first hashed output 208. At step S404, the second hashed output 209 is stored in the data object 204a, although this is not essential.

Following the hashing of the customer-provided shared secret and the retrieved salt 206 at step S403 and the subsequent storage S404 of the second hashed output 209, the first hashed output 208 is retrieved from the data object 204a at step S405. The hash comparison module 203 then compares the first and second hashed outputs 208, 209 to determine whether there are any differences between them at step S406. The authentication server 104 outputs a simple true/false statement to the customer 101 and/or business 102, via their user interfaces 105, 106, informing them as to whether or not the hashed outputs match at step S407.

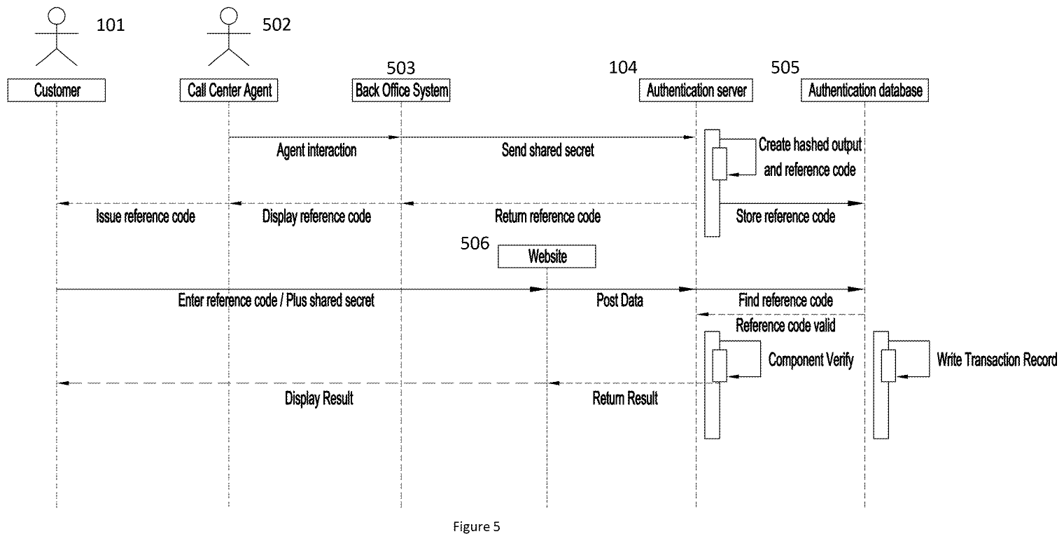

FIG. 5 depicts more clearly the flow of data between a customer 101, a call centre agent 502 of a business 102 and the third party server 104 when interacting with a system implementing an embodiment of the present invention. Firstly, during a call with a customer 101, the call centre agent 502 interacts with the business' back office system 503 to send information regarding the agreed-upon shared secret to the third party server 104. The server 104 then returns a reference code 207 to the back office system 503, and also stores the reference code 207 to the data object store 204 at a third party database 505 along with the salt 206 and the first hashed output 208. The back office system 503 displays the reference code 207 to the call centre agent 502, who then conveys it to the customer 101 over the telephone.

The customer 101 then interacts with the third party server 104 via, for example, a website interface 506 or an API. The customer 101 inputs the reference code 207 and the shared secret to the website 506 which communicates with the server 104. The server 104 sends the reference code 207 to the database 505 and retrieves the salt 206 and the first hashed output 208. The server 104 then hashes the customer's shared secret with the salt 206, stores and then outputs the second hashed output 209, as described in more detail above in relation to FIG. 4. The first and second hashed outputs 208, 209 are then compared, and the result of that comparison is sent to the customer 501, via the website 506.

The above description relates to a single exemplary embodiment of the invention. The skilled person will understand that some of the features of the invention may be altered for further benefits. Some of these alternatives are listed below.

In the embodiment described above the hashing module 201, the salt generation module 205, the reference module 202 and the comparison module 203 are located at the authentication server 104 which is remote from the customer 101 and business 103. In one alternative arrangement, one or more of the hashing module 201, the salt generation module 205, the reference module 202 and the comparison module 203 may be located within the customer's 101 and/or business' 102 devices, as part of an application or program. The hashed outputs 208, 209, the salt 206 and the reference code 207, once outputted, would then be sent to an authentication server 104 at a third party's 103 location which stores them in the data object store 204. In this manner, the third party server 104 never receives sensitive information, whether in clear text or encrypted, but is merely required to store the relevant data for processing at the customer's or business' devices.

In a further alternative arrangement, only one, two or three of the modules 201, 202, 203, 205 are located remotely from the server 104. If only the hashing module 201 is located at a customer device 105, 106, the reference code 207 received from the customer 101 is sent to the authentication server 104 in order to retrieve the salt 206, which must then be sent back to the customer device 105, 106 before they are input into the hashing module 201. Similarly, the first hashed output 208 may be compared, using the hash comparison module 203, with the second hashed output 209 at the customer device. If the comparison is performed at the customer's device 105, 106, the reference code 207 is used to retrieve the first hashed output 208 and send it the customer device 105, 106 for the comparison S406.

In another alternative arrangement, the reference code 207 is not required to be formed by shortening or minifying, i.e., creating a user friendly reference for the first hashed output 208. In this arrangement, the reference code 207 may be a simple code randomly assigned to refer to a particular group of data or the first hashed output 208 itself. Alternatively, the reference code 207 may be the first hashed output 208. If this is the case, the system 103 is not required to generate a separate reference code 207, simplifying the process performed by the server 104.

In a further alternative arrangement, the website 506 may be an application on the customer's smart phone, or other device. In further alternative embodiments, the communication between a customer 101 and a call centre agent 502 may take place via SMS, a telephone call, an email exchange, or other form of media.

It is to be understood that the exemplary embodiment described above is also applicable to non-electronic forms of communication. For example, a customer 101 may receive a package (or letter) in the post, from a business 102. The customer 101 may wish to verify that the package is from the business 102, and may therefore call, or email a customer services department of the business 102 in order to authenticate that the package is from the business 102, by performing the steps of the exemplary embodiment. Alternatively, the package may be marked with a reference code 207 and an indication as to the shared secret used to generate the reference code 207. The shared secret may be chosen at random by the business 102, or agreed previously with the customer 101 (for example, when placing an order, or setting up an account). The customer 101 is then able to use the reference code 207 and input the shared secret, as in the exemplary embodiment, and authenticate that the business 102 sent the package. This embodiment differs from the above exemplary embodiment in that the reference code 207 is provided by the business 102 to the customer 101 in a non-electronic manner. The steps of generating the first hashed output 208 and the reference code 207, and the steps of generating the second hashed output 209 and comparing the two hashed outputs 208, 209 remain the same.

The skilled person will realise that some of the steps of various above-described methods are performed by programmed computers. Accordingly the above-mentioned embodiments should be understood to cover storage devices containing machine-executable or computer-executable instructions to perform some or all of the steps of the above-described methods. The embodiments are also intended to cover computers programmed to perform the steps of the above-described methods.

The functionality of the elements shown in the Figures can be provided using either dedicated hardware and/or software. The expressions “processing”, “processing means” and “processing module” can include, but is not limited to, any of digital signal processor (DSPs) hardware, network processors, application specific integrated circuits (ASICs), field programmable gate arrays (FPGAs), read only memories (ROMs) for storing software, random access memories (RAMs), and non volatile storage.

We claim:

1. A method of authentication, comprising:
hashing, at a hashing module of a server, a first item of information provided by a first user with a salt to produce a first hashed output;
storing, by the server, the salt and the first hashed output in a data object;
generating, by a reference code module at the server, a reference code and storing it in the data object;
providing, by the server, the reference code to a second user;
receiving, by the server from the second user, a second item of information and the reference code;
retrieving, by the hashing module, and with the reference to the reference code the stored salt from the data object;
hashing, by the hashing module, the second item of information received from the second user with the retrieved salt to produce a second hashed output;
comparing, at a hash comparison module of the server, the first hashed, output with the second hashed output; and
determining, by the hash comparison module, whether the first and second hashed outputs are the same, thereby determining whether the first and second items of information are the same.

2. A method of authentication as claimed in claim 1, further comprising, before the first hashing step: sharing a plurality of items of information between the first user and the second user, wherein the first item of information is one of the plurality of shared items of information.

3. A method of authentication as claimed in claim 2, wherein the first item of information is a part of one of the plurality of the shared items of information.

4. A method of authentication as claimed in claim 2, further comprising, before the first hashing step: selecting, by one or both of the first and second users, the first item of the plurality of items to be provided by the first and second users.

5. A method of authentication as claimed in claim 1, wherein the reference code is a shortened form of the first hashed output.

6. A method of authentication as claimed in in claim 1, wherein the first item is sent to the hashing module via an application or a website.

7. A method of authentication as claimed in claim 1, wherein the server is remote from the first and second users.

8. A method of authentication as claimed in claim 1, wherein one or more of the hashing module, the hashing comparison module and the reference code module are located at a customer device.

9. A method of authentication as claimed in claim 1, wherein the plurality of shared items of information are two or more of: a date of birth, a mother's maiden name, a whole or part of an address, a school, a bank account number, a credit/debit card number, a personal identification number and a password.

10. A method of authentication as claimed in claim 1, wherein the salt is randomly generated by a salt generation module.

11. A method of authentication, comprising:
sharing, between a first user and a second user, one or more secrets;
receiving, at a hashing module and from the first user, a first secret of the shared secrets;
hashing, at the hashing module, the first secret with a randomly generated salt to form a first hashed output;
creating, by a reference module, a reference code relating to the salt and the first hashed output;
storing, in a data object at a data object store, the reference code, the salt and the first hashed output;
sending, from the data object store to the first user, the reference code;
sending, by the first user to the second user, the reference code;
receiving, at the hashing module and from the second user, the first shared secret and the reference code;
retrieving, from the data object and based on the reference code, the salt;
sending, to the hashing module by the data object store, the salt;
hashing, by the hashing module, the first shared secret received from the second user with the salt to form a second hashed output;
receiving, at a hash comparison module, the first hashed output from the data object store and the second hashed output from the hashing module;
comparing, by the hash comparison module, the first hashed output with the second hashed output;
determining, by the hash comparison module, whether the first and second hashed outputs are identical; and
sending, by the hash comparison module, to one or both of the first and second users, a statement relating to the comparison.

12. A system of authentication comprising:
a first user device;
a second user device, in communication with the first user device; and
a server, in communication with the first and second user devices via a network, comprising a hashing module, a reference code module and a hash comparison module, wherein the first user device, the second user device and the server are configured to perform the method steps of:
hashing, at the hashing module, a first item of information provided by the first user device with a salt to produce a first hashed output;
storing, by the server, the salt and the first hashed output in a data object;
generating, by the reference code module; a reference code and storing it in the data object;
providing, by the server and via the first user device, the reference code to the second user device;
sending, by the second user device to the server, a second item of information and the reference code;
retrieving, by the hashing module, and with reference to the reference code the stored salt from the data object;
hashing, by the hashing module, the second item of information received from the second user with the retrieved salt to produce a second hashed output;
comparing, at the hash comparison module, the first hashed output with the second hashed output; and
determining, by the hash comparison module, whether the first and second hashed outputs are the same, thereby determining whether the first and second items of information are the same.

13. An authentication server storing instructions that, when executed, cause the server to perform the steps of:
hashing a first item of information provided by a first user with a salt to produce a first hashed output;
storing the salt and the first hashed output in a data object; generating a reference code and storing it in the data object; providing the reference code to a second user;
receiving, from the second user, a second item of information and the reference code;
retrieving, with reference to the reference code, the stored salt from the data object;
hashing the second item of information with the retrieved salt to produce a second hashed output;
comparing the first hashed output with the second hashed output; and
determining whether the first and second hashed outputs are the same, thereby determining whether the first and second items of information are the same.
